(19) United States
(12) Patent Application Publication
(10) Pub. No.: US 2026/0141680 A1
(43) Pub. Date: May 21, 2026

(54) SYSTEM AND METHOD FOR IMAGE AND VIDEO TRANSMISSION OPTIMIZATION USING A TRAINED MODEL

(71) Applicant: PRE INC., TORONTO (CA)

(72) Inventors: YIQIAN QIN, Toronto (CA); Parham Aarabi, Toronto (CA)

(21) Appl. No.: 18/953,659

(22) Filed: Nov. 20, 2024

(51) Int. Cl. G06V 10/764; G06N 3/0475; G06V 10/82

(52) U.S. Cl. CPC G06V 10/764; G06N 3/0475; G06V 10/82

(57) ABSTRACT

A system and method utilizes a trained model (e.g. a deep neural network, such as a convolutional neural network trained to process images) to provide quantitative and qualitative feedback on one or more images/videos thereby allowing for image/video transmission, storage and usage to be optimized based on the feedback from the trained model.

### FIELD

The present disclosure relates to image processing and to deep neural networks and artificial intelligence (AI), and more particularly to a system and method for image and video transmission optimization using a trained model

### BACKGROUND

There is significant benefit in the ability to estimate the level of user engagement with a specific visual content, including but not limited to images on an e-commerce site, visual posts on social media, and content on a marketing campaign or ad, (herein, the term “social media/social network” is used to denote either one or both of such services). If, for example, marketers or influencers are able to know the number of likes generated by potential image(s) they are about to post, they can optimize which image is posted to maximize engagement. Or, if certain visuals or content on an e-commerce site is more likely to be engaging by the audience, then this knowledge can be used to optimized the site. Prior work has evaluated the type and characteristic of visual content that generate higher engagement, with the work of quantitatively measuring engagement of visual elements on a social media/social network service. The result of this work is a clear indication that the contents of images can be linked to the level of engagement (measured by the number of likes) for each specific content. For example, it has been found that professionally shot images generally have higher engagement than non-professional visual content.

Visual content, however, is not the only metric affecting engagement. Other factors, such as text, comment, personal factors related to the poster, and the circumstances when the post was made can each impact the level of engagement. As a result, the purely visual analysis of image content will be limited in its ability to precisely estimate engagement of visual social media/social network content.

### SUMMARY

In accordance with an embodiment, a system and method utilize a trained model (e.g. a deep neural network, such as a convolutional neural network trained to process images) to provide quantitative and qualitative feedback on one or more images/videos thereby allowing for image/video transmission, storage and usage to be optimized based on the feedback from the trained model.

In accordance with an embodiment, provided is a system and method to train a deep neural network to classify visual content as either engaging (class 1) or non-engaging (class 0). Confidence levels for class 1 from the estimator are used to estimate the number of likes for specific visual communications such as social media/social network posts, email message, web page content, etc.

In accordance with an embodiment, a storage medium such as a database storing data records associated with the visual content is maintained responsive to the classification. In an example, visual content can be removed. A communication record can be stored or updated with the visual content. Text based comments / descriptions for the visual content can be generated using a (trained) visually aware large language model. Data records can be updated with at least some of the comments. The communication can include or be updated with some of the comments, for example, a social media/social network post can be updated by way of commenting in reply to the social media/social network post, or an e-commerce site element can be described based on its visual content and sales promotions.

In an embodiment, there is provided a (software-based) tool for generating a communication such as a social media/social network post. The tool utilizes a trained model for classification to classify candidate images for a new post, maintains data records in response to the classification, generates the new post in response to the classification and, optionally, obtains comments from a trained visually aware large language model such as for the candidate image used in the new post. In an embodiment, other optional functions of the tool include an image scaling function to scale the candidate image for processing by either model or image editing/processing function to prepare the candidate image for the new post.

System, method and computer program product aspects of the teachings herein will be apparent to those of ordinary skill in the art. A computer program product comprises at least one (non-transient) storage device storing instructions executable by at least one processor to cause the at least one processor to perform a method.

### BRIEF DESCRIPTION OF THE DRAWINGS

FIG. 1 is a block diagram of a computing system including a trained deep neural network model in accordance with an embodiment.

FIG. 2 is a block diagram of a computing system including a trained deep neural network model in accordance with an embodiment, the computing system configured to evaluate the trained deep neural network.

FIG. 3 is an illustration of a user interface in accordance with an embodiment.

FIG. 4 is a block diagram of a computing environment including a trained deep neural network model in accordance with an embodiment, the environment comprises a computing system configured (e.g. with a software-based tool) to define a communication such as a social media/social network post or an (e-commerce) web site element using the trained model.

FIG. 5 is a block diagram of a computing device 502 configured (e.g. using software-based components) for managing media, in accordance with an embodiment.

FIG. 6 is a block diagram of a computing environment including a trained deep neural network model in accordance with an embodiment, the computing environment comprises a system that is configured (e.g. with a software-based tool) to obtain candidate images from a plurality of generative AI models, to evaluate the candidate images using the trained deep neural network model, and to define a communication such as a social media/social network post in response to the evaluating.

### DETAILED DESCRIPTION

### Introduction

Deep learning, a subfield of machine leaning, is based on multi-layer artificial neural networks (ANNs) that are loosely inspired by the visual perception mechanism of the living creatures. Due to its strong ability to discover intricate structures in high-dimensional data, deep learning has brought significant improvements in various fields (e.g., computer vision, natural language processing, and drug discovery).

One of the most notable deep learning architectures is convolutional neural network (CNN or ConvNet) which has accomplished astonishing results on a variety of pattern recognition tasks, such as image classification. Among various types of deep CNN, one of the most well-known one is VGGNet, proposed by the visual geometry group at the University of Oxford.

In accordance with an embodiment herein, there is built and trained a lightweight model based on Tiny VGG, a version of VGGNet, for a task at hand. The trained Tiny VGG-based model is better suited for a small-sized dataset, more computationally efficient, is less prone to overfitting as compared to VGGNet. Further the Tiny VGG based model is built and trained to classify two classes of visual information, including engaging (class 1) and non-engaging (class 0). In accordance with an embodiment, confidence levels for class 1 identified visual information are further used to predict the number of likes for specific visual social media/social network posts. A method is further described herein that incorporates the trained model into a workflow process in accordance with an embodiment.

### Custom Dataset

In an embodiment, a custom dataset contains 2,400 images, having 50% engaging images (with engagement defined manually by human observers), and 50% non-engaging images. The images were sourced from publicly available sources. The dataset was partitioned into two sets, with 2,048 images used for model training and 352 images used to evaluate the classification accuracy of the trained model. To preprocess the data, each image was resized to a fixed resolution of 64×64, horizontally flipped in a random fashion with 50% probability, and scaled into a range [0, 1].

Engagement can be determined based on a variety of factors, including, but not limited to, the number of social engagements with a visual social media/social network post (for example, the number of likes on an image posted on a social media/social network service), with using the average number of engagements for an account as a threshold by which to measure engagement level (for example, if the number of likes on a photo is X % higher than the average, then it has high engagement, and if it is Y % lower, then it has low engagement). Engagement can also be measured by generating or searching for specific keywords such as “fancy fashion outfits” and “plain boring outfits”, with the keywords determining engagement. It can also be measured manually based on a panel of human or visual AI systems that can look at specific images and ascertain potential engagement.

In an embodiment, during training of the Tiny VGG-based model, cross-entropy loss function was used to measure the similarity between the predicted probability distribution (the class confidence levels) and the target distribution (the ground truth class labels). Adaptive moment estimation, a stochastic optimization algorithm, was used to adjust model weights iteratively to minimize the cross-entropy loss. The initial learning rate was set to 5×10⁻⁵, and the mini-batch size was fixed as 12. In total in an embodiment, the example model was trained for 100 cycles through the entire training set of 2,048 images.

### Architectural Details

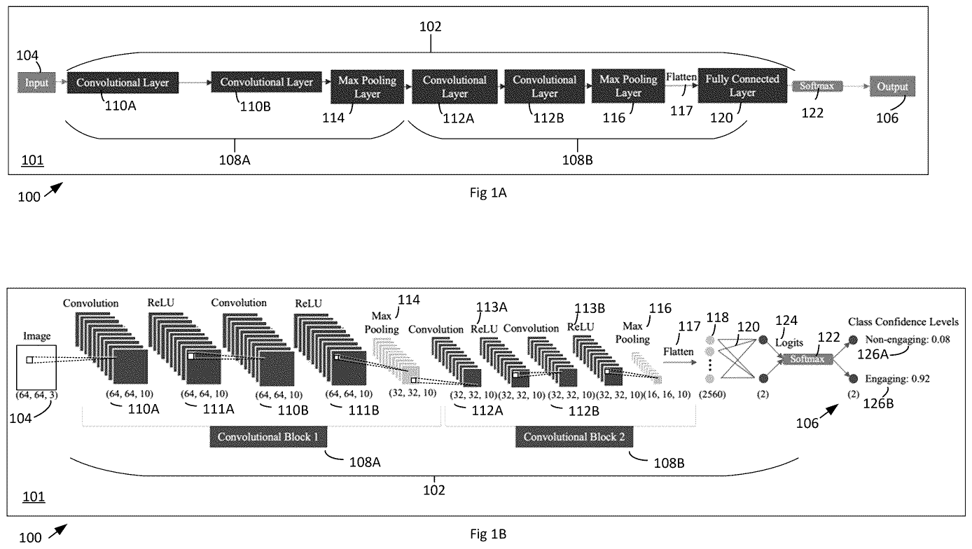

FIGS. 1A and 1B are block diagrams of a computing system 100 in accordance with an embodiment, where FIG. 1B shows additional detail relative to FIG. 1A. System 100 comprises hardware components and software components to store and execute a trained deep neural network model (e.g. trained model 102) for processing images (e.g. image 104) to produce output (e.g. output 106). In an embodiment, the trained model comprises a plurality of trained parameters (not specifically shown). In an embodiment, system 100 comprises a laptop computer, tablet, smartphone, server or other form of computer, having at least one processor (not shown) (e.g. a CPU (central processing unit) and/or a GPU (graphics processing unit)), and memory and/or other storage devices (e.g. 101) storing instructions that when executed by the at least one processor configure system 100 to perform operations of a method, for example, processing an image using the trained model 102. Other components of the system 100 can include a display device, pointer device, keyboard, microphone, speaker, location device, communication subsystem, camera, etc., which can be coupled to or comprise a component of the computer. System 100 can couple to a network (in a wired or wireless manner), in an embodiment, such as for communicating an input image or output of the trained model, etc.

In an embodiment, the trained model 102 comprises a Tiny VGG-based model having 8132 trainable parameters in total. As seen in FIG. 1B, trained model 102 contains 5 layers with weights (including 4 convolutional layers and 1 fully connected layer) as further described. In an embodiment, image 104 comprises a “still” image (e.g. a photograph). In an embodiment, image 103 comprises one image (or frame) of a plurality of images (frames) such as from a video (not shown).

In an embodiment, input 104 to trained model 102 is a 64×64 RGB image. First, input 102 is passed through 2 convolutional blocks 108A/108B (convolutional block 1 and convolutional block 2 in FIG. 1B). Each convolutional block (108A/108B) comprises a stack of 2 convolutional layers (e.g. 110A/110B and 112A/112B) and 1 max-pooling layer (e.g. 114 and 116). Specifically, each convolutional layer uses 10 kernels with a receptive field of size 3×3, with a convolution stride of 1 pixel and padding of 1 pixel (cf. FIG. 1B). A Rectified Linear Unit activation function (ReLU) 111A/111B and 113A/113B is applied to every convolutional layer (110A/110B and 112A/112B). The max-pooling layer (114 and 116) uses a 2×2 kernel and a stride of 2 pixels (cf. FIG. 1B).

After passing through both convolutional blocks (108A/108B), the interim output is flattened 117 into a one-dimensional vector 118, which then becomes the input of a fully connected layer 120. Last, a softmax activation function 122 normalizes the fully connected layer's interim output (i.e. logits 124) into level of confidence (a value ranging from 0 to 1) for each class 126A/126B.

Confidence levels 126A/126B serve two purposes: (i) to evaluate the classification accuracy of the trained model, and (ii) to predict the number of likes for specific visual social media/social network posts as further described herein, in accordance with an embodiment.

To quantitively evaluate classification accuracy, in an embodiment, test images were processed by trained model 102 and respective outputs 106 obtained. The output instances comprise respective confidence levels for each class (engaging vs non-engaging).

In an embodiment, the class with the higher confidence level is considered the predicted outcome. For example, if the confidence level is 0.92 for class 1 (engaging) and 0.08 for class 0 (non-engaging), the predicted class of this image is class 1 (engaging). In accordance with an example of the trained model 102, it achieved 90.3% overall classification accuracy on 352 test images, with 91.5% accuracy for class 1 and 89.2% for class 0.

### Model Evaluation

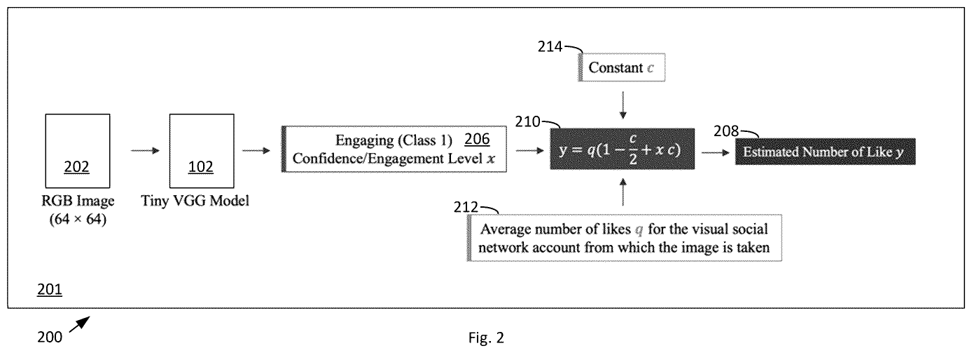

A separate set of 1,350 images from a visual social network from users with a large number of followers (at least 100,000) was collected. The number of likes for each image was also collected. FIG. 2 is a block diagram showing a computing system 200 including one or more storage devices (e.g. 201) storing an instance of trained model 102 and various data as further described for determining an estimated number of likes such as for evaluation with an actual number of likes. As illustrated in FIG. 2, an instance 202 of the set of collected images from the social network set was processed by trained model 102 (e.g. as an engagement classifier), obtaining a score x 206 (e.g. an instance of output 106) ranging from 0 to 1 with 1 indicating high likelihood of engagement and 0 indicating low likelihood of engagement. Image engagement level x 206 was converted into an estimated number of likes y 208 based on the following formula: y=q(1−c/2+x c) 210, where q 212is the average number of likes for the account from which the image is taken and c 214 is a constant. Hence, the number of estimated likes would range from q(1−c/2) to q(1+c/2).

The estimated number of likes y 208 was compared with the actual number of likes z (not shown), with accuracy being estimated as 1−|y−z|/z (not shown). The images from the social network were filtered a) by selecting the single most representative image if there were multiple images in a single post, b) if the accuracy of a post was below a threshold, then that particular post would be considered as a noise/outlier and excluded from the analysis. Based on the evaluation of the 1,350 social images, having a noise/outlier threshold of 0 results in a maximum overall accuracy of 75% occurring at c=0.8. Increasing the noise-outlier threshold to 0.3 results in a maximum overall accuracy of 79% also occurring at c=0.8. The evaluation illustrates that a deep learning model trained on evaluating image engagement can estimate the number of likes with an accuracy ranging in between 75-80% (with better results if noise/outliers posts are excluded). In an embodiment, the set of images from the social network were stored in a datastore (not shown) in association with the respective number of likes, for example in data records. Related images from a post were also associated. A filter operation to perform filtering such as described is also not shown.

### Application

Various applications of the trained model are apparent to those of ordinary skill in the art. In an embodiment, the trained model is integrated into a method for image and video transmission optimization.

In an embodiment, responsive to the classification (e.g. non-engaging) for an input image or the classification (e.g. engaging) and the respective confidence level/estimate of likes for the input image, an additional action is taken. Responsive to a classification that image 104 is non-engaging, an additional action can comprise, for example, deleting or updating a datastore record for the image 104 or a candidate image that corresponds to image 104. A candidate image corresponding to image 104 is, for example, an instance of image 104 at a different resolution, such as a higher resolution.

In an embodiment, a candidate image is one of a set of candidate images for communicating as a content part of a communication. In an embodiment, a communication comprises a social media/social network post. In an embodiment, a communication comprises an email message. In an embodiment, a communication comprises a web page. In an embodiment, a communication comprises another type of communication.

In an embodiment, a set of candidate images comprises a series of photographs such as from a photo shoot showing one or more products. In embodiment, at least one product is presented by a model, for example, as worn or applied to the model, etc. The products may comprise clothing, footwear, or headwear, or beauty products such as hair or makeup products. The model and/or products may be real or simulated such as by image processing techniques including generative AI or other AI techniques.

In an embodiment, the set is stored to a datastore for processing to obtain a classification from the trained model for each of at least a subset of images thereof. Responsive to the processing, and particularly the classification obtained for the candidate image, it is selected or not selected for use in the communication. A non-engaging classification is thus useful to reduce the use of processing resources for the candidate image. A candidate image that is rejected as non-engaging need not be processed such as for use in a communication or communicated. The candidate image (e.g. a datastore data record therefor) may be deleted, in an embodiment, or its classification data updated in the data record for the candidate image.

In an embodiment, for the candidate image having a classification that is engaging and/or further having an engaging confidence level/estimate of likes over a threshold, an additional action can comprise one or more of the following: i) defining a new datastore record or updating an existing datastore record for the communication to include content comprising the candidate image; ii) processing the candidate for use as the content of communication; iii) obtaining comments for the candidate image suggested by a trained visually aware large language model configured to generate comments using image processing and generative AI; iv) communicating the candidate image for the communication or communicating at least one comment for the communication.

Thus, in an embodiment, the classification for the candidate image can be used to either automatically or manually choose between one or more social media/social network posts BEFORE the posts are made. This way, a user can take a series of photos, and a computing system configured with the trained model is enabled to choose which one would have the highest engagement and only post based on the engagement metric.

In an embodiment, the engagement metric can also be used to generate one or more (e.g. a series) of social media/social network comments based on the post. Using a visually aware large language model (for example, GPT-4o™, from OpenAI, Inc.), a computing system can be implemented to suggest key positive elements of the post along with potential areas for improvement. The ratio of positive to improvement posts can be optionally set based on the user engagement metric (i.e. highest estimated engagement posts would have only positive comments, lowest estimated engagement posts would have only improvement moments).

In an embodiment, the engagement metric can be supplemented by a large language model which would describe the image, and another large language model that can estimate an engagement metric from the image description. In this embodiment, a sales, discount, or promotion depicted as a visual element of an e-commerce site can be related to a higher engagement level. As one example, the engagement supplement could be added to, replace, multiplied to, or combined in any other way with the base engagement metric.

In an embodiment, the placement, size, color, and contents of an e-commerce site element, when combined with knowledge of the user engagement with the content as outlined in this patent, can be used to predict the click-through rates (CTR for the element). Elements positioned prominently, such as above the fold or near high-traffic sections, are more likely to capture attention. Similarly, larger elements with visually appealing colors that align with brand identity but also stand out against the background can draw users'eyes more effectively. The content within the element—such as clear, actionable text, high-quality images, or enticing offers—further influences user interaction.

In another embodiment, the system outlined here can be combined with a deep neural network that detects multiple visual elements on an image (e.g. screenshot of a website, a multi-image ad, a presentation, etc.) in order to assess the engagement of each element relative to the other elements.

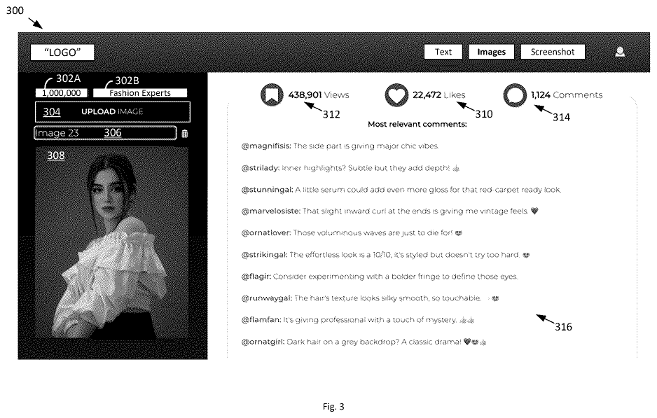

FIG. 3 is an example illustration of user interface 300 related to a social media/social network service, in accordance with an embodiment. In an embodiment, interface 300 is configured to predict likes and views for a social media/social network post by processing a candidate image for the post using at least some of the methods and techniques described herein.

In an embodiment, interface 300 provides respective controls 302A and 302B providing the ability to set an estimated number of followers for a social media/social network account (1 million as the default) and the primary category of the social media account's followers (e.g. fashion experts). Further controls 304 and 306 selectively upload or delete a new (candidate) image 308 for the post. In this embodiment, the number of likes 310 are determined (predicted) as per the methodology outlined in this document including processing the candidate image 308.

The estimated number of views 312 are a set proportion: (with a +/−5% random perturbation) based on the total number of social media followers (i.e. in the shown example, the views are 45% of the follower +/−5%), and the number of comments 314 are a set proportion based on the number of estimated likes (in the shown case, the number of comments are 5% of the number of estimated likes +/−1%). The comments 316 themselves are simulations of user reaction. In an embodiment, each comment is obtained from a generative AI model that processes a prompt and the image to generate the comment. In an embodiment, respective comments can be obtained from more than one generative AI model, for example, for comment diversity. A prompt can request a positive or a negative comment to simulate user engagement. In an embodiment, the image is processed by an object classifier (not shown) to generate a list of objects in the image. The list of objects is used to define the prompts.

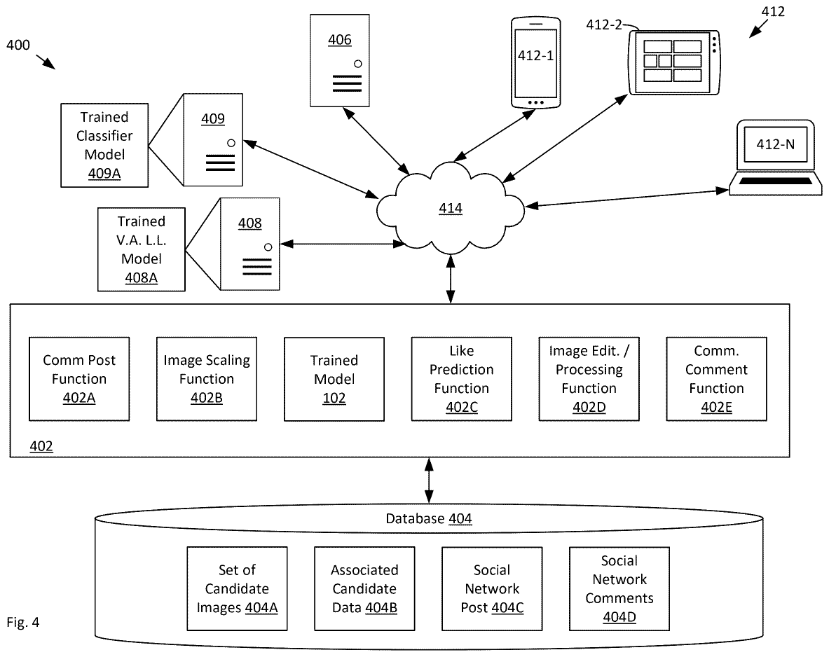

FIG. 4 is a block diagram of a computing environment 400 in accordance with an embodiment. Environment 400 comprises a computing system 402 configured (e.g. with a software-based tool) for defining a communication, a database 404 storing various data and coupled for communication with computing system 402, a social media/social network computing system 406 providing services of a s social media/social network, a AI service computing system 408 to provide services of a trained visually aware large language model 408A, and a plurality (N) of social media/social network user computing devices 412 (comprising devices 412-1, 412-2, 412-N).

Also shown is a communication network 414 coupling systems 402, 406, 408 and devices 412. Network 414 may comprise one or more networks such as a public or a private network, whether such is a wired or a wireless network. An example network is the Internet.

Computing system 402 and database 404 may be coupled via a network such as a local area network or a wide area network, including network 404 or may be a component of system 402. In an embodiment database 404 represents an organized collection of data and comprises a database management system. In another embodiment another type of data store based other storage can be used.

It will be appreciated that the environment 400 is simplified. Any computing system herein can comprise the hardware components previously described herein with reference to system 100, or the like.

Computing system 402 comprises a plurality of software components such as for generating (defining) a communication. Components include a communication post function 402A, an image scaling function 402B (optional), trained model 102, a predicted likes function 402C, an image editing/processing function 402D (optional), and a communication comment function 402C (optional).

Communication post function 402A provides a user interface (UI) to define a new communication such as a new social media/social network post. In an embodiment, the new communication is defined from a template (not shown). A plurality of (different) templates can be provided having predefined visual feature, etc. for selection of e.g. one for the new communication.

At least a portion of the template is populated with application content, for example, visual content. An example of visual content is a photograph, another example is a video.

In an embodiment comprising the use of photographs, for example, a set of candidate images 404A for the visual content are stored to database 404. Also stored is associated candidate data 404B for the candidate images. Associated data can comprise product information for product shown in the image, model data, photo shoot information, classification output, predicted likes, communication data, etc. A person of skill in the art will appreciate that suitable modifications can be made for video type visual content.

In an embodiment, a candidate image is selected from the set 404A a user interface from system 402 (not shown). In an embodiment, a plurality of UI controls is provided for invoking applicable functions with which to define the new communication. Controls can be associated with a candidate image selected for processing to determine whether to use the image for the new communication.

In an embodiment, the UI may use a workflow approach to lead a user through the definition of a new communication.

In an embodiment, a control is provided for an image scaling function 402A. Function 402A is configured to processes an input image to scale (e.g. downscale) a candidate image to a new size/resolution e.g. for subsequent processing. Candidate images such as from a photo set can be of a resolution suitable for display as a component of a communication by a user device, such as one of devices 412. In the present context, function 402A downscales a candidate image to a required scale for providing as input to trained model 102. Image scaling function 402A is optional, for example, such as if pre-scaled images associated with the candidate images are available (e.g. stored such as to database 404).

In an embodiment, a control is provided to process an appropriately downscaled image by trained model 102 to obtain classification output. In an embodiment, a control is provided to determine predicted likes for the candidate image using function 402C. In an embodiment, a single control is provided to: scale the candidate image, process the scaled image using the trained model to obtain classification output and e.g. responsive to the classification, process the classification output to obtain the predicted likes. In an embodiment, the predicted likes function (or initiation of its functionality) is responsive to the respective class in the classification output and only provides predicted likes when the class is “engaging”. In an embodiment, the UI displays the class output and the predicted likes, for example.

In an embodiment associated candidate data 404B is updated in response to classification and like prediction, as applicable. In an embodiment, responsive to classification of a candidate image as non-engaging, further action is undertaken. For example, database 404 (i.e. records thereof) are updated-the set of candidate images and associated candidate data are respectively updated such as by deleting the respective data.

In an embodiment, a subset of the set of candidate images are processed to distinguish engaging and non-engaging images and to determine respective predicted likes. In an example, as user interface facilitates selection of a plurality of images from the set and a control invokes the classification and like prediction. In an embodiment, a user interface display results, for example, ordering the candidate images processed by predicted likes (or classification output).

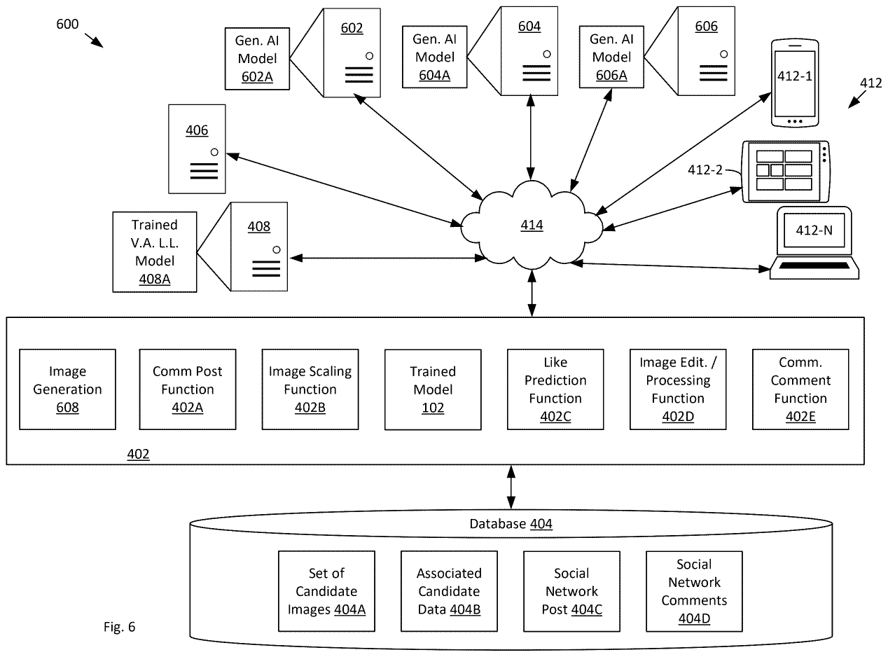

In an embodiment, a UI control is provided to include a candidate image as the visual content in the communication. The database is updated with the communication (e.g. social media/social network post 404C). The associated candidate data for the respective candidate image is updated in the database to indicate the inclusion. In an embodiment, the associated candidate data indicates the particular communication, for example. Though FIG. 4 provides an embodiment for a communication post via a social media/social network service, the components may be adapted for a communication post to a website (e.g. a webpage element) for communication to at least some users of a website or via other communication service such as via email, text message/short message service (SMS), etc. The same applies to the embodiment of FIG. 6 herein below.

In an embodiment, a control is provided to send the communication, for example, posting via social media/social network system 406 and in association with an applicable user account/handle for the social media/social network service. In an embodiment, though not shown, the communication is posted via an application interface provide by or for the social media/social network service associated with system 406. System 406, in turn, distributes the communication to at least some of user devices 412, such as those devices that are associated to enrolled users of the service and in particular to those who are or followers of the account associated with the post or to those who are addressed in the post. The term “followers” herein includes friends, subscribers or other types of users who are enlisted to receive (e.g. in the user's feed, the senders or receivers timeline or other message interface) general posts by the sending account. A general post can be contrasted with a private message (e.g. a “PM”) post or a direct message (e.g. a “DM”) post sent by the sending account to a specific user or selected group of users who are identified to receive the post. In some social media/social network services, a general post is (e.g. publicly) available to non-followers such as by searching or other manner of locating.

Thus, in an embodiment, computing device 402 is configured to generate a general post to followers using visual information that is scored using the trained deep learning model and/or to generate a DM or PM post to identified users where the DM or PM comprises visual information that is scored using the trained deep learning model. That is, any type of social media/social networking post including visual information can be defined in response to a score from the trained deep neural network model.

Optionally, responsive to selection for use in the communication, the image editing/processing function 402D is used to process the candidate image prior to inclusion in the communication. Processing may include applying one or editing filters, or colour, lighting or other adjustments etc. to ready the candidate image. The processed candidate image is stored to database 404 for use as the visual content in the communication.

In an embodiment, communication comment function 404E is invoked (e.g. via a UI control) to obtain at least one comment from AI service computing system 408. The candidate image/visual content is provided to system 408 for processing by trained visually aware large language model 408A. One or more comments are received in reply. In an embodiment, for example, responsive to features of model 408A/the service provided by system 408, a textual prompt is provided to illicit a specific type of comments that simulates user engagement. In an embodiment, the candidate image is provided to an object classifier service 409 having a trained classifier model 409A that classifies objects in the candidate image, providing a listing thereof in reply. Database 404 is updated with at least one comment 404D and association between the at least one comment is made to the communication and/or to the visual content therein (e.g. via associated candidate data 404B).

In an embodiment, at least some of the comments are posted via the social media/social network service of system 406, which comments are also distributed by the service to at least some user devices 412, in accordance with the operation of the social media/social network service. In an embodiment, comment(s) posted via social media/social network system 406 are in association with respective user account(s)/handle(s) for the social media/social network service, which is typically different from the account/handle used to post the communication with the visual content, with each comment having a respective different account/handle as well. In an embodiment, though not shown, the comment(s) is(are) posted via an application interface provide by or for the social media/social network service associated with system 406.

Though the components of system 402 are shown as a tool to define social media/social network posts, the tool may be modified to define other communication types such as an email message (e.g. for communication to a list of followers), a web page, a video sharing service, or another type of communication. Generated comments and posting of comments may be applicable to some types of communications (e.g. social media/social network posts) but not others (emails). In an embodiment, a candidate image is used as visual content for a plurality of types of messages such as part of a multi-channel campaign.

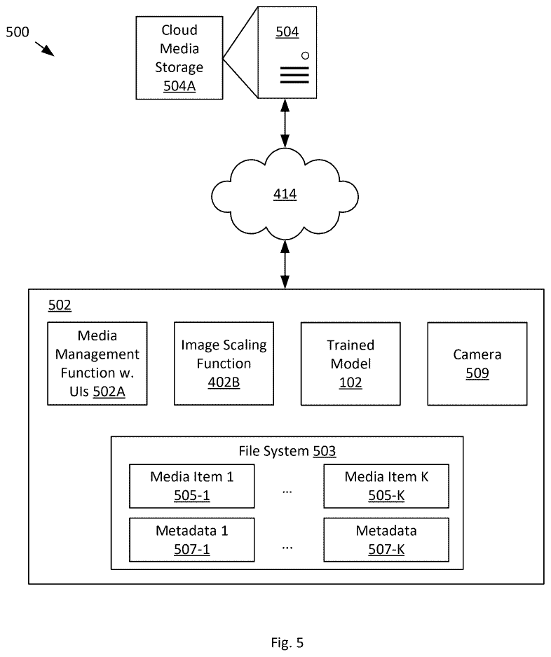

FIG. 5 is a block diagram of a computing device 502 configured (e.g. using software-based components) for managing media, in accordance with an embodiment. Computing device 502 is shown in communication with a cloud computing system 504 via network 414. Cloud computing system 504 provides cloud media storage 504A to store media items and metadata therefor (both not shown) as a service. Computing system 502 comprises a file system 503 storing a plurality (K) of media items 505-1 to 505-K. In an embodiment, each of the media items 505-1 to 505-K are associated with respective metadata 507-1 to 507-K. Media items 505-1 to 505-K comprise images (e.g. photographs) and/or videos, for example. In an embodiment, media items 505-1 to 505-K are defined (e.g. captured) by camera 509. In an embodiment, metadata 507-1 to 507-K comprises information about the items 505-1 to 505-K, such as, descriptive metadata, administrative metadata, reference metadata, legal metadata, etc. In an embodiment, metadata includes class data and a classification score such as determined by trained model 102.

In an embodiment, cloud computing system 504 stores media items for computing device 502, such as in accordance with a user account for the service. A (particular) media item stored in cloud media storage 504A can comprise a copy of a (particular) media item in file system 503 or may be different from any of items 505-1 to 505-K. Could computing system 504 can provide a (cloud-based) backup service.

To manage media items on cloud media storage 504A and/or in file system 503, computing device 502 is configured with a media management function 502A, a software-based component or tool. The tool provides i) a UI (not shown) to (selectively) classify respective media items using trained model 102 and ii) media item management operations comprising operations to copy, move, and or delete respective items responsive to the classification. The copy, move, or delete operations are in relation to either or both of store 504A or file system 503. In an embodiment, respective classification output and/or a score value computed therefrom is stored as a content of metadata in association with the respective media items as processed. Cloud storage device 504A can also store metadata in association with the respective media items.

In an embodiment, metadata can be used to interact with and/or manage media items such as by filtering, sorting, displaying, copying, backing up, removing/deleting, sending, etc. manage media items based on metadata content(s), in either computing device 502 or cloud computing system 504. In an embodiment, applicable UIs are provided, such as via media management function 502A.

In an embodiment, media management function 502A is configured to enable a non-engaging media item to be automatically stored to cloud storage 504A but removed from file system 503 (or vice versa). In an embodiment, media management function 502A is configured to enable a non-engaging media item to be automatically removed from both cloud storage 504A and from file system 503. In an embodiment, media management function 502A is configured to enable an engaging media item with a score value below a threshold to be automatically removed from one of both of store 504A and file system 503. A control is provided to set or adjust the threshold value. In an embodiment, media manage function 502A is enabled to filter media items in accordance with their respective score values. For example, the function 502A may only display filtered media items (e.g. or thumbnails derived therefrom) having a score value above a first threshold or below a second threshold (which may be the same value).

In an embodiment, a new capture of a media item (e.g. a photo or a video) prompts a user to invoke the media management function to process the new item to classify and score it. The media item is processed responsive to the score, for example, to delete it, move it to the cloud store, etc.

Media management function 502A and metadata for media items can be provided by computing device 402 and/or aspects of functions 502A and the metadata can be combined with the features of communication post function 402A and/or communication comment function 402E.

### Generative AI Selector

In another embodiment, the image engagement estimation outlined above can be used to select a most engaging image from multiple outputs generated by at least one generative AI model. In an embodiment, candidate images such as for a social media/social network post are obtained by executing respective image generation queries on at least one image generator service providing a generative AI model that generates images. Example services or AI image generator models include Dall-E 3™ from Open AI, Inc. and Adobe Firefly™ from Adobe Inc.

In an embodiment, the same effective query prompts are provided to at least two image generator services/models to obtain respective candidate images from the different services/models. In an embodiment, different queries are sent to a same service/model to obtain respective candidate images responsive to the different queries. In an embodiment, though the queries are different, they are related to seek similar images that differ in certain specific respects, for example, varying a product color, a gender, or a physical characteristic of a model between related prompts. For example, a prompt may seek a female model with blonde hair wearing a sparkling red gown and another may prompt seek a female model with brunette hair wearing a red gown. In an embodiment, image prompts may comprise natural language inputs for processing by the respective image generator service using its respective model(s) to generate an image in reply.

In an embodiment, the respective candidate images are evaluated to determine respective levels of engagement. The images are provided to the trained deep neural network for processing to predict (e.g. or score) the engagement for each such as described herein. Workflow of a software tool may assist to generate the prompts, communicate to respective services, receive reply images and provide (e.g. two or more of) them for processing. Workflow can identify (e.g. rank) the images responsive to the score and can be configured to choose a highest score so as to select the one most likely to captivate users. Uses of such a system include areas of e-commerce, digital advertising, and content creation, where selecting the most engaging visual content can enhance user engagement, increase conversion rates, and provide personalized experiences. By automating image selection, this system ensures that the most engaging result from multiple image generators is used.

FIG. 6 is a block diagram of a computing environment 600 including a trained deep neural network model in accordance with an embodiment, the computing environment is configured (e.g. with a software-based tool) to obtain candidate images from a plurality of generative AI models, to evaluate candidate images using the trained deep neural network model, and to define a communication such as a social media/social network post in response to the evaluating. Environment 600 is similar to environment 400, however, environment 600 includes a plurality of generative AI image services 602, 604 and 606, that are coupled for communication with computing system 402. Generative AI image services 602, 604 and 606 each have respective generative AI models 602A, 604A and 606A for generating images responsive to prompts received via the service's respective API or other (public) interfaces (not shown).

In an embodiment of environment 600, computing system 402 is configured with an image generation function 608 (e.g. including a user interface (not shown)) to generate prompts, communicate with a respective service and obtain candidate images such as for use as candidate images 404A. In the embodiment, computing system 402 is configured to rank the candidate images and define a social media/social network post. In an embodiment a user interface is configured to receive input to presents a plurality of candidate images, receive input to select among the plurality, and to provide the selected candidates for processing (e.g. via like prediction function 402C). Results of the processing are provided (e.g. in a user interface (not shown)) that displays respective scores and/or ranks the images responsive to the scores (e.g. respective likes). In an embodiment, user input selects a scored image for a post. In an embodiment, system 402 automatically selects a scored image (e.g. based on a highest score or a threshold score (e.g. at least X likes) or other criteria). The user interface can be configured to receive input such as per interface 300 to identify the number of followers and the area or category associated with the followers of the social media/network account.

The following numbered statements provide a summary of curtained embodiments and features that will be apparent to a person of ordinary skill in the art.

Statement 1: A computer implemented method for optimizing usage of visual information, the method comprising: processing an image comprising the visual information with a trained deep neural network model configured to provide classification output indicating a likely level of user engagement with the visual information; and storing, deleting, transmitting, or otherwise using the image in response to the likely level of user engagement.

Statement 2: The method of Statement 1, wherein storing, deleting, transmitting, or otherwise using the image comprises defining a communication post for communication to one or more user devices, the communication post including the visual information.

Statement 3: The method of Statement 2, wherein the communication post comprises: a post to a social media/social network service for communication to at least some users of the social media/social network service, the users associated with the one or more user devices; or a website post to a website for communication to at least some users of the website, the users associated with the one or more user devices.

Statement 4: The method of Statement 3 comprising providing a user interface to receive input to: identify the image for processing to obtain the likely level of user engagement; and define the post to include the visual information.

Statement 5: The method of Statement 4 comprising obtaining a score value from the trained deep neural network model; defining the likely level of user engagement to comprise a number of likes for the visual information; and presenting the number of likes via the user interface.

Statement 6: The method of Statement 5 comprising processing the visual information to generate a plurality of representative comments, the representative comments simulating user engagement with the communication post; and presenting the comments in the user interface.

Statement 7: The method of Statement 6, comprising processing the visual information with a trained classifier to obtain a list of objects depicted in the visual information and wherein the processing to generate the plurality of comments is responsive to at least some of the objects from the list of objects to diversify the comments.

Statement 8: The method of Statement 6, wherein a count of the plurality of comments generated is proportionate to the number of likes.

Statement 9: The method of Statement 4 comprising receiving input defining a number of followers to a social media/social network account associated with the communication post; determining a number of views for the communication post that is proportionate to the number of followers; and presenting the number of views in the user interface.

Statement 10: The method of Statement 1, wherein the image comprises a first candidate image and wherein the method comprises: obtaining the first image from a generative AI image service; obtaining a second image from a same or a different generative AI image service; processing the second image using the trained deep neural network to determine a likely level of engagement with the second image; and comparing i) the likely level of engagement with the first image; and ii) the likely level of engagement with the second image; wherein the storing, deleting, transmitting or otherwise using the first image is further responsive to the comparing.

Statement 11: The method of Statement 1 comprising: storing a plurality of media items and respective metadata therefor in data records, wherein each media item of the plurality of media items comprises an instance of visual information, wherein the image is derived from or comprises one of the media items and wherein the data records are configured to store respective classification output as metadata for respective media items as processed by the trained deep neural network; and updating the data records for the one of the media items associated with the visual information with the classification information obtained by processing the image.

Statement 12: The method of claim 1, wherein at least one of a) or a) and b): (a) the trained deep neural network model comprises a convolutional neural network adapted to classify two classes of visual information comprising an engaging class and a non-engaging class, and wherein class confidence levels for the engaging class are used to predict a number of likes for the visual information; (b) the trained deep neural network model comprises a Tiny VGG-based model trained using supervised learning techniques employing a cross-entropy loss measuring a similar between a predicted probability distribution of the class confidence levels and the target distribution of ground truth class labels for training images.

Statement 13: One or more computer storage media devices storing instructions that when executed by at least one processor of a computing system cause the computing system to provide a method for optimizing a storage, transmission or other usage of visual information comprising: processing an image comprising the visual information with a trained deep neural network model configured to provide classification output indicating a likely level of user engagement with the visual information; and storing, deleting, transmitting or otherwise using the image in response to the likely level of user engagement.

Statement 14: The one or more computer storage media devices of Statement 13, wherein the storing, deleting, transmitting or otherwise using the image comprises defining a communication post for communication to one or more user devices, the communication post including the visual information.

Statement 15: The one or more computer storage media devices of Statement 14, wherein the communication post comprises a post to a social media/social network service for communication to at least some users of the social media/social network service, the users associated with the one or more user devices; or a website post to a website for communication to at least some users of the website, the users associated with the one or more user devices.

Statement 16: The one or more computer storage media devices of Statement 15, wherein the instructions when executed cause the computing system to provide a user interface to receive input to: identify the image for processing to obtain the likely level of user engagement; and define the post to include the visual information.

Statement 17: The one or more computer storage media devices of Statement 16, wherein the instructions when executed cause the computing system to: obtain a score value from the trained deep neural network model; define the likely level of user engagement to comprise a number of likes for the visual information; and present the number of likes via the user interface.

Statement 18: The one or more computer storage media devices of Statement 17, wherein the instructions when executed cause the computing system to: process the visual information to generate a plurality of representative comments, the representative comments simulating user engagement with the communication post; and present the comments in the user interface.

Statement 19: The one or more computer storage media devices of Statement 18, wherein the instructions when executed cause the computing system to process the visual information with a trained classifier to obtain a list of objects depicted in the visual information and wherein the processing to generate the plurality of comments is responsive to at least some of the objects from the list of objects to diversify the comments.

Statement 20: The one or more computer storage media devices of Statement 18, wherein a count of the plurality of comments generated is proportionate to the number of likes.

Statement 21: The one or more computer storage media devices of Statement 16, wherein the instructions when executed cause the computing system to: receive input defining a number of followers to a social media/social network account associated with the communication post; determine a number of views for the communication post that is proportionate to the number of followers; and present the number of views in the user interface.

Statement 22: The one or more computer storage media devices of Statement 13, wherein the image comprises a first candidate image and wherein the instructions when executed cause the computing system to: obtain the first image from a generative AI image service; obtain a second image from a same or a different generative AI image service; process the second image using the trained deep neural network to determine a likely level of engagement with the second image; and compare i) the likely level of engagement with the first image; and ii) the likely level of engagement with the second image; and wherein the storing, deleting, transmitting or otherwise using the first image is further responsive to the comparing.

Statement 23: A computing device comprising at least one processor and at least one storage device, the at least one storage device storing instructions executable by the at least one processor to cause the computing device to: provide a user interface to define a post for communication via a social media or social network service, a website or other communication service, the user interface adapted to:
receive input to select a candidate image comprising visual information for including in the post; process the candidate image using a trained deep neural network model to predict a likely level of user engagement with the post comprising the visual information, wherein the trained deep neural network model comprises a classifier to classify images into an engaging class and a non-engaging class and confidence levels for the engaging class are used to provide a prediction of a number of likes for the post; present the number of likes in the user interface; and receive input to use or not use the candidate image for the post responsive to the prediction.
Statement 24: The computing device of Statement 24 wherein the user interface is configured to at least one of: a) determine a prediction of the number of views of the post; or b) obtain using a generative artificial intelligence (AI) model a plurality of comments simulating use engagement with the visual information, the generative AI model trained to process images and provide text descriptions for the images.
Statement 25: A computing device comprising at least one processor and at least one storage device, the at least one storage device storing instructions executable by the at least one processor to cause the computing device to: obtain a plurality of candidate images from at least one generative artificial intelligence (AI) model trained to generate images; process the plurality of candidate images using a trained deep neural network model to obtain respective predictions of a likely level of user engagement with visual information within the candidate images, the trained deep neural network model comprising a classifier to classify an image into an engaging class and a non-engaging class and provide confidence levels for the engaging class for determining a prediction of the likely level of user engagement; determine a ranking of the plurality of candidate images responsive to the respective predictions; and present or otherwise use the plurality of candidate images responsive to the ranking.

Practical implementation may include any or all of the features described herein. These and other aspects, features and various combinations may be expressed as methods, apparatus, systems, means for performing functions, program products, and in other ways, combining the features described herein. A number of embodiments have been described. Nevertheless, it will be understood that various modifications can be made without departing from the spirit and scope of the processes and techniques described herein. In addition, other steps can be provided, or steps can be eliminated, from the described process, and other components can be added to, or removed from, the described systems. Accordingly, other embodiments are within the scope of the following claims.

Throughout the description and claims of this specification, the word “comprise” and “contain” and variations of them mean “including but not limited to” and they are not intended to (and do not) exclude other components, integers or steps. Throughout this specification, the singular encompasses the plural unless the context requires otherwise. In particular, where the indefinite article is used, the specification is to be understood as contemplating plurality as well as singularity, unless the context requires otherwise.

Features, integers characteristics, compounds, chemical moieties or groups described in conjunction with a particular aspect, embodiment or example of the invention are to be understood to be applicable to any other aspect, embodiment or example unless incompatible therewith. All of the features disclosed herein (including any accompanying claims, abstract and drawings), and/or all of the steps of any method or process so disclosed, may be combined in any combination, except combinations where at least some of such features and/or steps are mutually exclusive. The invention is not restricted to the details of any foregoing examples or embodiments. The invention extends to any novel one, or any novel combination, of the features disclosed in this specification (including any accompanying claims, abstract and drawings) or to any novel one, or any novel combination, of the steps of any method or process disclosed.

1. A computer implemented method for optimizing usage of visual information, the method comprising:
processing an image comprising the visual information with a trained deep neural network model configured to provide classification output indicating a likely level of user engagement with the visual information; and
storing, deleting, transmitting, or otherwise using the image in response to the likely level of user engagement.

2. The method of claim 1, wherein storing, deleting, transmitting, or otherwise using the image comprises defining a communication post for communication to one or more user devices, the communication post including the visual information.

3. The method of claim 2, wherein the communication post comprises: a post to a social media/social network service for communication to at least some users of the social media/social network service, the users associated with the one or more user devices; or a website post to a website for communication to at least some users of the website, the users associated with the one or more user devices.

4. The method of claim 3 comprising providing a user interface to receive input to:
identify the image for processing to obtain the likely level of user engagement; and
define the post to include the visual information.

5. The method of claim 4 comprising obtaining a score value from the trained deep neural network model; defining the likely level of user engagement to comprise a number of likes for the visual information; and presenting the number of likes via the user interface.

6. The method of claim 5 comprising processing the visual information to generate a plurality of representative comments, the representative comments simulating user engagement with the communication post; and
presenting the comments in the user interface.

7. The method of claim 6, comprising processing the visual information with a trained classifier to obtain a list of objects depicted in the visual information and wherein the processing to generate the plurality of comments is responsive to at least some of the objects from the list of objects to diversify the comments.

8. The method of claim 6, wherein a count of the plurality of comments generated is proportionate to the number of likes.

9. The method of claim 4 comprising receiving input defining a number of followers to a social media/social network account associated with the communication post; determining a number of views for the communication post that is proportionate to the number of followers; and presenting the number of views in the user interface.

10. The method of claim 1, wherein the image comprises a first candidate image and wherein the method comprises:
obtaining the first image from a generative AI image service;
obtaining a second image from a same or a different generative AI image service;
processing the second image using the trained deep neural network to determine a likely level of engagement with the second image; and
comparing i) the likely level of engagement with the first image; and ii) the likely level of engagement with the second image;
wherein the storing, deleting, transmitting or otherwise using the first image is further responsive to the comparing.

11. The method of claim 1 comprising:
storing a plurality of media items and respective metadata therefor in data records, wherein each media item of the plurality of media items comprises an instance of visual information, wherein the image is derived from or comprises one of the media items and wherein the data
records are configured to store respective classification output as metadata for respective media items as processed by the trained deep neural network; and
updating the data records for the one of the media items associated with the visual information with the classification information obtained by processing the image.

12. The method of claim 1, wherein at least one of a) or a) and b):
(a) the trained deep neural network model comprises a convolutional neural network adapted to classify two classes of visual information comprising an engaging class and a non-engaging class, and wherein class confidence levels for the engaging class are used to predict a number of likes for the visual information;
(b) the trained deep neural network model comprises a Tiny VGG-based model trained using supervised learning techniques employing a cross-entropy loss measuring a similar between a predicted probability distribution of the class confidence levels and the target distribution of ground truth class labels for training images.

13. One or more computer storage media devices storing instructions that when executed by at least one processor of a computing system cause the computing system to provide a method for optimizing a storage, transmission or other usage of visual information comprising:
processing an image comprising the visual information with a trained deep neural network model configured to provide classification output indicating a likely level of user engagement with the visual information; and
storing, deleting, transmitting or otherwise using the image in response to the likely level of user engagement.

14. The one or more computer storage media devices of claim 13, wherein one the storing, deleting transmitting or otherwise using the image comprises defining a communication post for communication to one or more user devices, the communication post including the visual information.

15. The one or more computer storage media devices of claim 14, wherein the communication post comprises: a post to a social media/social network service for communication to at least some users of the social media/social network service, the users associated with the one or more user devices; or a website post to a website for communication to at least some users of the website, the users associated with the one or more user devices.

16. The one or more computer storage media devices of claim 15, wherein the instructions when executed cause the computing system to provide a user interface to receive input to:
identify the image for processing to obtain the likely level of user engagement; and
define the post to include the visual information.

17. The one or more computer storage media devices of claim 16, wherein the instructions when executed cause the computing system to: obtain a score value from the trained deep neural network model; define the likely level of user engagement to comprise a number of likes for the visual information; and present the number of likes via the user interface.

18. The one or more computer storage media devices of claim 17, wherein the instructions when executed cause the computing system to: process the visual information to generate a plurality of representative comments, the representative comments simulating user engagement with the communication post; and present the comments in the user interface; and wherein a count of the plurality of comments generated is proportionate to the number of likes.

19. The one or more computer storage media devices of claim 17, wherein the instructions when executed cause the computing system to: receive input defining a number of followers to a social media/social network account associated with the communication post; determine a number of views for the communication post that is proportionate to the number of followers; and present the number of views in the user interface.

20. A computing device comprising at least one processor and at least one storage device, the at least one storage device storing instructions executable by the at least one processor to cause the computing device to:
provide a user interface to define a post for communication via a social media or social network service, a website or other communication service, the user interface adapted to:
receive input to select a candidate image comprising visual information for including in the post;
process the candidate image using a trained deep neural network model to predict a likely level of user engagement with the post comprising the visual information, wherein the trained deep neural network model comprises a classifier to classify images into an engaging class and a non-engaging class and confidence levels for the engaging class are used to provide a prediction of a number of likes for the post;
present the number of likes in the user interface; and
receive input to use or not use the candidate image for the post responsive to the prediction.
